(19) United States
(12) Patent Application Publication
(10) Pub. No.: US 2026/0158681 A1
(43) Pub. Date: Jun. 11, 2026

(54) COMPENSATION DEVICE, SYSTEM WITH HANDLING DEVICE AND WITH COMPENSATION DEVICE, METHOD FOR CONTROLLING A HANDLING DEVICE AND A COMPENSATION DEVICE

(71) Applicant: SCHUNK SE & Co. KG Spanntechnik Greiftechnik Automatisierungstechnik, Lauffen am Neckar (DE)

(72) Inventors: Samuel Härer, Besigheim (DE); Thomas Feucht, Brackenheim (DE); Frank Clemens Schnittker, Damme (DE); René Korte, Öhringen (DE)

(21) Appl. No.: 19/405,777

(22) Filed: Dec. 2, 2025

(30) Foreign Application Priority Data
Dec. 5, 2024 (DE) 102024136297.9

(51) Int. Cl. B25J 17/02; B25J 9/16

(52) U.S. Cl. CPC B25J 17/0208; B25J 9/1633

(57) ABSTRACT

A compensation device for an automation system is disclosed. The device is configured for arrangement between a handling device and a tool and includes a first compensation unit having a first base part and a first compensation part that is movable between a basic position and a compensation position. The device further includes at least one second compensation unit having a second base part and a second compensation part that is movable between a basic position and a compensation position. At least one locking unit is provided for locking at least one of the first compensation part and the second compensation part in its basic position, the locking unit including a locking element displaceable within a locking housing between a release position and a locking position. At least one of the first base part and the first compensation part is integrated into the locking housing.

### TECHNICAL FIELD

This disclosure relates to compensation devices used in automation systems. It further relates to systems that include a handling device and a compensation device, and to methods for controlling a handling device together with a compensation device.

### BACKGROUND

The weight of compensation devices tends to increase when additional compensation directions are provided. As more directions are added, the geometric center of gravity of the compensation device can shift farther away from the robot flange or other mounting interface of a handling device. This can lead to reduced permissible loads for the handling device and can contribute to increased energy consumption and mechanical wear during operation.

### SUMMARY

Unless otherwise defined in this disclosure, terms are intended to have their ordinary and customary meaning as understood by a person of ordinary skill in the art at the time of filing, in view of the present disclosure. The definitions set forth below are provided for clarity of certain terms used in the description and the claims, and are not intended to be limiting unless expressly stated.

The term “compensation device” refers to an assembly that provides mechanical yielding and/or positional adjustment between a handling device and a tool, for example to compensate misalignment or tolerances during handling or joining of workpieces. A compensation device can include one or more compensation units and one or more locking units.

The term “compensation unit” refers to a mechanism that permits movement of one component relative to another component along at least one degree of freedom, such as linear movement along an axis or rotational movement about an axis, between a basic position and a compensation position. Examples include vertical, horizontal, and rotatory compensation units.

The term “vertical compensation unit” refers to a compensation unit that permits movement along a direction that is designated in this disclosure as a Z-axis. The term “horizontal compensation unit” refers to a compensation unit that permits movement along at least one direction that is designated as an X-axis and/or a Y-axis. The term “rotatory compensation unit” refers to a compensation unit that permits rotational movement about at least one of the X-axis, Y-axis, or Z-axis. The labels X-axis, Y-axis, and Z-axis are used as a convenient frame of reference and do not limit the compensation device to any particular orientation in use.

The term “basic position” refers to a reference position of a compensation part relative to an associated base part, for example a neutral position or rest position, from which the compensation part can move into a compensation position. The term “compensation position” refers to a position of the compensation part that is displaced from the basic position as a result of a compensation movement.

The term “locking unit” refers to a mechanism that, in a locking position, restricts or prevents movement of an associated compensation part along at least one degree of freedom, and that, in a release position, permits such movement. A locking unit can include a locking housing, a locking element, and one or more pressure chambers for pneumatic or hydraulic actuation.

The term “controller” refers to any hardware, firmware, software, or combination thereof that is configured to process input data and to generate control signals for the handling device, the compensation device, or components thereof. A controller can include one or more processors and memory devices storing instructions that, when executed by the processors, cause the controller to perform one or more of the functions described in this disclosure. Examples of controllers include microcontrollers, programmable logic controllers, and industrial computers.

The term “sensor device” refers to any device configured to detect at least one state or parameter of an associated component, such as position, stroke, path, or locking state, and to output a corresponding electrical signal. Examples of sensor devices include incremental sensors, inductive position detection sensors, and magnetic sensors.

The term “computer-implemented method” refers to a method in which one or more of the steps are performed using at least one controller that executes stored instructions, processes sensor data, and generates control signals, as described in this disclosure.

One aim of the present disclosure is to provide a compensation device with a plurality of compensation directions that can be implemented in a flatter and lighter configuration.

The present disclosure relates to a compensation device for an automation system, in particular for arrangement between a handling device and a tool. The compensation device comprises a first compensation unit with a first base part and with a first compensation part, the first compensation part being arranged to be movable relative to the first base part between a first basic position and a first compensation position. The compensation device further comprises at least one second compensation unit with a second base part and with a second compensation part, the second compensation part being arranged to be movable relative to the second base part between a second basic position and a second compensation position. The compensation device comprises at least one locking unit for locking the first and/or the at least one second compensation part in the second basic position with a locking element that is displaceable in a locking housing between a release position and a locking position. The first base part is integrated in the locking housing and/or in the second compensation part. Alternatively, the first compensation part is integrated in the locking housing and/or in the second base part.

In one embodiment, the first compensation unit has a first locking unit for locking the first compensation part and the second compensation unit has a second locking unit for locking the second compensation part. The first base part can be integrated into the locking housing of the first locking unit. The first compensation part can be integrated in the second base part and the locking housing of the second locking unit.

Due to the integral construction of one of the components of the first compensation unit and of the locking housing of the locking unit or of a further compensation unit, in particular the integration of the first base part within the first locking housing and the integration of the first compensation part in the second base part and in the second locking housing, a flat and lightweight compensation device is provided. The respective locking housing and the respective base part thus coincide in the individual compensation units. This moves the geometric center of gravity of the load arranged on the handling device, such as the compensation device, as well as the tool and the workpiece, closer to the robot flange. In addition, the number of components used to create the compensation and/or locking function is reduced and weight and installation height are saved.

In some aspects, a compensation device is arranged on a robot flange of a handling device. The compensation device can comprise one or both of the following components: a horizontal compensation unit with a horizontal locking unit, a vertical compensation unit with a vertical locking unit. The compensation device can alternatively comprise the following components: a rotary compensation unit with a rotary locking unit, a vertical compensation unit with a vertical locking unit. The compensation device can furthermore alternatively comprise the following components: a horizontal compensation unit with a horizontal locking unit, a rotary compensation unit with a rotary locking unit, a vertical compensation unit with a vertical locking unit.

In aspects of the present disclosure, for the rotary compensation unit (W-angle compensation) a rotation about an X-axis and/or about a Y-axis and/or about a Z-axis is meant. The compensation units and/or the locking units can be arranged one behind the other along the Z-axis. A horizontal compensation unit provides compensation along the X and Y-axes. A vertical compensation unit provides compensation along the Z-axis. References to directions such as X-axis, Y-axis, Z-axis, vertical, horizontal, upper, lower, or similar terms are made for convenience in describing example orientations of components, and do not limit the compensation device to any particular orientation unless explicitly stated.

The compensation device has a first compensation unit, a second compensation unit and a third compensation unit, which are interchangeable as desired.

One aspect of the present disclosure provides that the locking unit is driven pneumatically and/or hydraulically. Accordingly, the locking element located in the locking unit can be operated or activated and deactivated particularly easily.

One aspect of the present disclosure provides that the locking housing delimits a cylinder chamber, and wherein the locking element comprises a piston portion arranged in the cylinder chamber. The piston portion divides the cylinder chamber into a first pressure chamber and a second pressure chamber, it being possible for pressure to be applied to at least one or both for driving the piston portion and the locking element.

One aspect of the present disclosure provides that the first compensation unit has a first spring device for returning the first compensation part to the first basic position, and wherein the first spring device is arranged on or in the locking housing. Accordingly, yieldingness is provided in a simple manner.

One aspect of the present disclosure provides that the first compensation unit has a first guide, in particular in the form of ball bushings, and wherein the first guide device is arranged in the locking housing. Accordingly, a guided movement of the spring device of the first compensation part is ensured.

One aspect of the present disclosure provides that the first compensation part is arranged to be movable relative to the first base part along a Z-axis from the first basic position into the first compensation position. Thus, the first compensation unit within the meaning of the present disclosure is designed vertically, in order to enable vertical compensation.

One aspect of the present disclosure provides that the at least one second compensation part is arranged to be movable relative to the at least one second base part along an X-axis running perpendicularly to the Z-axis, and along a Y-axis running perpendicularly to the X-axis, from the second basic position into the second compensation position. Thus, the second compensation unit is configured horizontally in the sense of the present disclosure, to allow horizontal compensation.

One aspect of the present disclosure provides that the at least one second compensation part is arranged so as to be pivotable relative to the at least one second base part in a rotational manner about the X-axis and about the Y-axis, from the second basic position into the second compensation position. Thus, the second compensation unit is configured to be rotatory in the sense of the present disclosure.

In some aspects of the present disclosure, both a vertical compensation unit and a horizontal compensation unit are provided in a compensation device.

In some aspects of the present disclosure, both a vertical compensation unit and a rotatory compensation unit are provided in a compensation device.

In some aspects of the present disclosure, both a horizontal compensation unit and a rotatory compensation unit are provided in the compensation device.

In some aspects of the present disclosure, a vertical compensation unit, a horizontal compensation unit and a rotatory compensation unit are provided in a compensation device.

One aspect of the present disclosure provides that the locking element is displaceable within the locking housing of the locking unit along the Z-axis between the release position and the locking position. In some aspects of the present disclosure, a horizontal, a rotatory and/or a vertical locking unit are provided in a compensation device.

The first base part of the vertical compensation unit can be formed integrally with the locking housing of the horizontal locking unit or with the locking housing of the rotatory locking unit.

One aspect of the present disclosure provides that the first compensation unit and/or the at least one second compensation unit has a compensation sensor device for detecting the position of the associated compensation part. Accordingly, the position of the respective compensation part can be detected in real time. Depending on the detected position data, the handling device carrying the compensation device can be positioned accordingly, so that a repeatable approach of the handling device to a workpiece is ensured even if the compensation device is deflected into a compensation position.

One aspect of the present disclosure provides that the at least one locking unit has at least one locking sensor device for detecting the position of the associated locking element. Accordingly, the locking state of the locking unit and the mobility of the compensation part operatively connected to the locking unit can be detected in real time.

One aspect of the present disclosure provides that the compensation sensor device and/or the locking sensor device are designed as an incremental sensor and/or as an inductive position detection sensor (IPD sensor) and/or as a magnetic sensor.

The present disclosure relates to a system having a handling device and having a compensation device, in particular as described above, the handling device having a handling controller and the compensation device having a compensation controller integrated into the handling controller. The plurality of compensation units of the compensation device each have a sensor device for detecting the position and/or the stroke and/or the path of the associated compensation part, the handling controller being configured such that it controls the handling device depending on the data detected by the sensor devices of the compensation devices. The plurality of locking units of the compensation device can each have a sensor device for detecting the position and/or the stroke and/or the path of the associated locking element, in particular the handling controller being configured such that it controls the handling device depending on the detected data of the sensor devices of the locking units.

In some implementations, the handling controller and the compensation controller each include at least one processor, such as a microcontroller, a programmable logic controller, or an industrial computer, and at least one memory device storing instructions that, when executed by the processor, cause the controller to perform the functions described herein. The controllers can be implemented as separate hardware units or as logical modules of a common control unit. The controllers can be coupled to the compensation device and to the handling device by wired or wireless communication interfaces in order to exchange sensor data, control signals, and status information in real time.

This ensures dynamic control of compensation units and locking units combined in the compensation device. Different positions of different workpieces can be approached precisely and repeatably using the dynamic controller, without the handling device having to realign itself with respect to the workpiece to be handled each time. This results in a considerable time saving when the handling device is approached sequentially or repeatedly to several workpieces, especially when many similar workpieces are to be handled in a short sequence.

Compensation units can be operated individually by a pneumatic supply. The pneumatic supply is individually controlled by a controller, which means that for a previously specified compensation case only a single controlled compensation in a specific direction can take place. In the case of combinations of several different and possibly even simultaneously activated compensation directions, the different compensation units can only be controlled individually, but not as a group. The controller of the individual compensation units for the respective application must be parameterized “statically” in advance for the compensation case and a specific compensation requirement.

Controllers in some existing systems can therefore only take into account statically preset and previously known compensation cases and compensation requirements. Dynamic flexibility of the controller when changing the application or the compensation case, e.g. by adding or removing one of the compensation directions, is not known from the prior art, and therefore the controller must be completely re-parameterized for the individual compensation devices. Furthermore, the actual compensation paths of the individual compensation units can either not be determined at all or only inaccurately.

A compensation controller integrated in the robot or handling controller can lock one of the combined compensation units during operation in the event of faults, overload or failure, or in the event that one compensation direction is not required, in order to prevent unwanted compensation in an undesired compensation direction and to prevent damage during operation. In this case, the compensation controller can use the sensor devices, in particular compensation sensor devices and/or locking sensor devices, to detect the detected positions and states of the respective compensation units, such as locked/unlocked, using a computer-implemented method.

The compensation controller can be configured to activate a plurality of locking units sequentially or as a group, in order to either block at least one compensation direction or to compensate only in at least one compensation direction.

The compensation controller can be configured in such a way that it selectively activates the respective locking unit to either block one compensation direction or to compensate only in one compensation direction.

The compensation controller can be configured in such a way that, depending on an existing compensation case, it automatically enables the compensation direction by moving the locking element into the release position (unlocking the respective locking unit) and thus releasing the required compensation direction.

The compensation controller can be configured such that, depending on the data detected by the sensor devices with regard to the respective compensation path, it controls (pre-positions) the compensation unit the next time the handling device is approached. In this case, the position that previously represented a path deviation can now be approached even more precisely and quickly. In this case, the starting point for the compensation controller can be, for example, the target position of the handling device with gripped workpiece. For example, a horizontal compensation device deflects by +1.77 mm in the X-direction and by −0.31 mm in the Y-direction during a first approach. The handling device thus reaches the target position and the workpiece can be processed, in particular joined. The values in the X-and Y-direction, as the respective deviation from the basic position, are detected by the sensor devices and made available to the compensation controller. The next time the same target position is approached, the handling device automatically moves to a position corrected by −1.77 mm in the X-direction and, at the same time, to a position corrected by +0.31 mm in the Y-direction. In this case, the compensation device can optionally be locked in the reference position and thus, for example, hits a hole position to be approached with repeat accuracy, so that another workpiece can for example be joined, for example with precise positioning, without the compensation device having to be controlled again in the X and/or Y-directions using the compensation controller.

In aspects of this disclosure, a computer-implemented method comprises:
a) detecting a compensation movement when approaching a target position by compensation sensor devices of a plurality of compensation units,
b) determining a compensation offset depending on the previously detected compensation movement,
   when approaching the target position again:
c) approaching the target position taking into account the determined compensation offset so that no movement or a smaller compensation movement of at least one of the compensation units is required, and
d) releasing the at least one compensation unit along the compensated compensation directions, and locking the at least one compensation unit along the uncompensated compensation directions by the associated locking units by controlling pneumatic connections depending on the determined compensation offset.

According to step d), for example compensation directions are blocked which previously did not require any compensation movement. This ensures repeatable and time-saving positioning. Compensation directions in which a compensation movement was required are released upon a subsequent approach. This step can be repeated for example as often as necessary, until no more compensation movement is required or the compensation movement falls below a threshold value. Alternatively, the correction can be omitted after a certain number of attempts, so that a compensation movement always occurs.

The different sensors are integrated and mounted in the respective housing of the compensation units. In this case, IPD sensors are directed at integrated switching cams that are mounted in or on the housing in such a way that the distance to the sensor changes with each compensation movement, so that the signal output by the sensor changes. The signal type at the sensor output can be either an analog or a digital signal. The compensation controller thus receives both the resulting signal (locking unit active/inactive) and the resulting compensation path signal in order to determine the actual compensation direction of the respective compensation device using the computer-implemented method. This allows information about the position and state of the respective compensation device to be used in the compensation controller in a number of ways.

This information can be used in the compensation controller, on the one hand to activate or deactivate individual compensation directions in real time, and on the other hand to compensate for a compensation offset determined during operation of the robot or handling device by a position correction in real time using the computer-implemented method (based on the determined compensation path information).

The data of the workpiece and the data of the compensation devices used in each case can be retrieved from a database by the compensation controller. In one aspect of the present disclosure, the compensation directions corresponding to the compensation case and the compensation effect, as well as the compensation paths of the individual compensation units, are determined by sensors and the compensation controller using a computer-implemented method. In one aspect of the present disclosure, data can be used within the computer-implemented method which represent AI-verified empirical values for the respective desired compensation effect and/or to predict possible compensation effects of a compensation device by AI. These can be stored in an application database for future applications or to optimize existing compensation effects, and be made available to other compensation controllers in real time.

Further advantages, features, and details emerge from the following description, in which various exemplary embodiments of the present disclosure are illustrated with reference to the drawings. The features mentioned in the claims and in the description may in each case be essential to the present disclosure individually or in any desired combination.

### BRIEF DESCRIPTION OF THE DRAWINGS

Further advantages, features, and details emerge from the following description, in which various exemplary embodiments of the present disclosure are illustrated with reference to the drawings. The features mentioned in the claims and in the description may in each case be essential to the present disclosure individually or in any desired combination. Identical and functionally corresponding elements are provided with identical reference signs.

In the drawings:

FIG. 1 is a perspective view of a compensation device with a horizontal, a vertical and a rotatory compensation unit;

FIG. 2 is an exploded view of the compensation device according to FIG. 1;

FIG. 3 is a first sectional view of the compensation device according to FIG. 1;

FIG. 4 is a second sectional view of the compensation device according to FIG. 1;

FIG. 5 is a sectional view of the exploded view according to FIG. 2;

FIG. 6 is a sectional view of a vertical compensation unit known from the prior art;

FIG. 7 is a perspective view of a compensation device with a horizontal and a vertical compensation unit;

FIG. 8 is a first sectional view of the compensation device according to FIG. 7;

FIG. 9 is a second sectional view of the compensation device according to FIG. 7;

FIG. 10 is a sectional view through a kit of modular compensation units for assembling a compensation device; and

FIG. 11 is a sectional view of a compensation device with sensor devices.

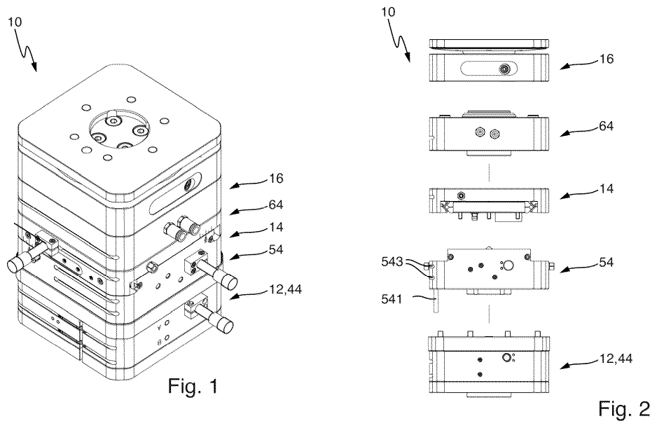

### DETAILED DESCRIPTION

The compensation device 10 is designed to be arranged between a handling device (not shown), in particular a robot arm and its robot flange, and a tool (not shown), in particular a gripper. According to FIGS. 1, 7 and 10, the compensation device 10 is modular in design and can therefore be constructed in different configurations.

According to FIG. 1, the compensation device 10 has a first compensation unit 12 in the form of a vertical compensation unit, a second compensation unit 14 in the form of a horizontal compensation unit, and a third compensation unit 16 in the form of a rotatory compensation unit.

According to FIG. 7, the compensation device 10 has a first compensation unit 12 in the form of a vertical compensation unit, and a second compensation unit 14 in the form of a horizontal compensation unit.

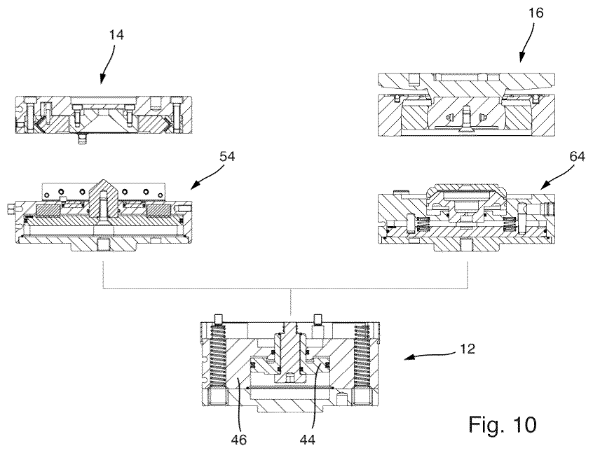

According to FIG. 10, the compensation device 10 can also have a first compensation unit 12 in the form of a vertical compensation unit, and a second compensation unit 14 in the form of a rotatory compensation unit.

A first compensation unit 12 in the form of a vertical compensation unit has a first base part 18 and a first compensation part 20, the first compensation part 20 being arranged to be movable relative to the first base part 18 along a Z-axis between a first basic position and a first compensation position. The compensation part 20 of the first compensation unit 12 can be arranged on the robot flange of the handling device. The base part 18 and the locking housing 46 of the first compensation unit 12 integrated therein can be arranged on the tool flange of the tool, in particular on the tool flange of a gripper.

According to FIG. 4, the first compensation unit 12 has a spring device 22, so that the compensation device 10 provides yieldingness along the Z-axis. The spring device 22 is supported on the one hand on the first base part 18 and on the other hand on the first compensation part 20. During a compensation movement, the first compensation part 20 is displaced against the spring force of the spring device 22.

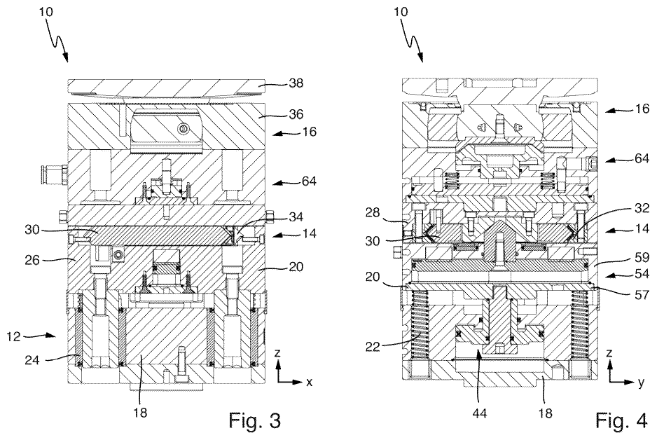

According to FIG. 3, the first compensation unit 12 further comprises a guide device 24 in the form of ball bushings, so that the first compensation unit 12 does not tilt and the spring device 22 is safely guided along the Z-axis by the guide device 24.

A second compensation unit 14 in the form of a horizontal compensation unit has a second base part 26 and a second compensation part 28, the second compensation part being arranged to be movable relative to the second base part 26, along an X-axis and along a Y-axis running perpendicularly thereto, between a second basic position and a second compensation position. When no further compensation unit is provided, the second compensation part 28 can be used as a tool flange for connecting the tool.

The second locking unit 54 includes a magnetic pin 541 for activating a magnetic sensor (not shown) of the first compensation unit 12. A permanent magnet is secured (e.g., glued) integrally to the magnetic pin 541 (not shown). By moving the magnetic pin 541 past a groove 543 of the second base part 26, into which the magnetic sensor is inserted (not shown), a change in the magnetic field of the magnetic sensor is generated.

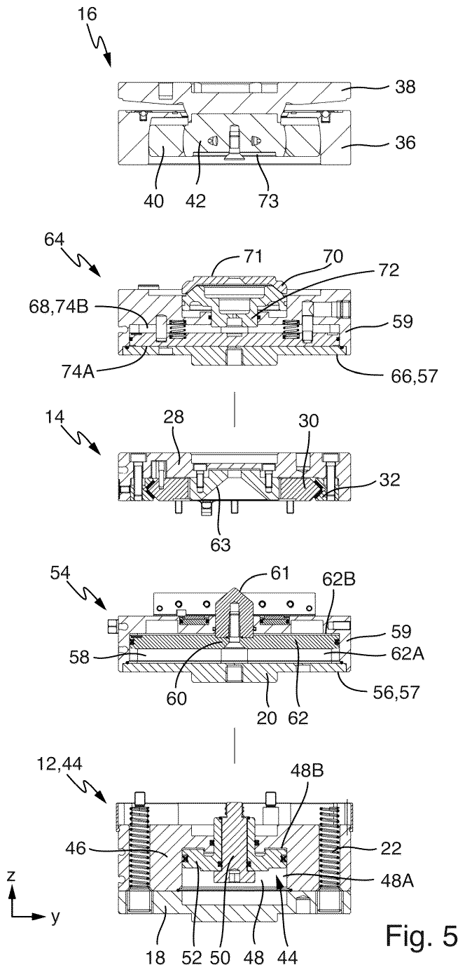

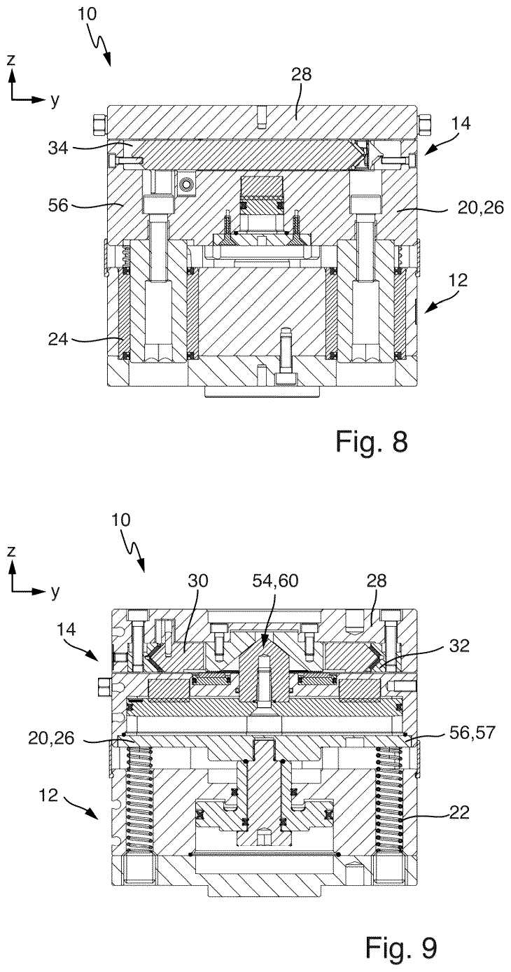

According to FIGS. 5, 8 and 9, the second compensation unit 14 has a guide frame 30 along the Z-axis between the second base part 26 and the second compensation part 28. In the assembled state, the second base part 26 and the second compensation part 28 form a substantially closed unit. The guide frame 30 is arranged so as to be movable relative to the second base part 26 along the X-axis in two first linear guides 32. The guide frame 30 is fixed relative to the second base part 26 along the Y-axis. The second compensation part 28 is arranged so as to be movable relative to the guide frame 30 along the Y-axis in two second linear guides 34. The second compensation part 28 is arranged so as to be fixed relative to the guide frame 30 along the X-axis. Overall, the second compensation part 28 can be moved along both the X-axis and along the Y-axis from the basic position into a compensation position by the guide frame 30.

A third compensation unit 16 in the form of a rotatory compensation unit has a third base part 36 and a third compensation part 38, the third compensation part 38 being arranged to be (rotationally) pivotable relative to the third base part 36 about the Z-axis between a third basic position and a third compensation position. If a third compensation unit 16 is provided, the third compensation part 38 is used as a tool flange for connecting the tool.

According to FIG. 3 to 5 and 10, the third compensation unit 16 has a bearing frame 40 and bearing core 42 arranged in the third base part 36. The bearing frame 40 is mounted in the third base part 36 so that it can rotate about the X-axis. The bearing core 42 is mounted in the bearing frame 40 so that it can rotate around the Y-axis. The bearing frame 40 and the bearing core 42 can form a cardanic joint (e.g., universal joint). The bearing core 42 is designed to be motion-resistant, in particular in one piece, with the third compensation part 38. Overall, the third compensation part 38 can be displaced (rotationally) from the third basic position into the compensation position by the bearing frame 40 and the bearing core 42, both about the X-axis and about the Y-axis.

The compensation movement of the compensation device 10 results from the sum of the compensation movements of the individual compensation units 12, 14, 16.

For returning the respective compensation part 20, 28, 38 from the compensation position to the basic position and/or for locking the respective compensation part 20, 28, 38 in the basic position, individual or all compensation units 12, 14, 16 can have locking units.

According to FIG. 5, the first compensation unit 12 has a first locking unit 44. The first locking unit 44 has a first locking housing 46, a first cylinder chamber 48, and a first cylinder portion 52 of the first locking element 50 arranged in the first cylinder chamber 48. The first locking housing 46 can be formed integrally with the first base part 18. The first cylinder portion 52 divides the first cylinder chamber 48 into a first primary pressure chamber 48A and a first secondary pressure chamber 48B. Pressure can be applied to the primary pressure chamber 48A and/or the secondary pressure chamber 48B in order to move the first locking element 50 between a release position and a locking position, along the Z-axis. In the release position of the first locking element 50, a compensation movement along the Z-axis can take place by the first compensation unit 12. In the locking position of the first locking element 50, no compensation movement along the Z-axis can take place by the first compensation unit 12, since the locking element 50 is connected to the first compensation part 20 and when pressure is applied to the secondary pressure chamber 48B the locking element 50 and also the first compensation part 20 are moved in the direction of the first base part 18.

According to FIG. 5, the second compensation unit 14 has a second locking unit 54. The second locking unit 54 has a second locking housing 56, a second cylinder chamber 58 and a second locking element 60. The second locking element 60 has a second cylinder portion 62 arranged in the second cylinder chamber 58, which divides the second cylinder portion 62 into a second primary pressure chamber 62A and a second secondary pressure chamber 62B. Pressure can be applied to the second primary pressure chamber 62A and/or the second secondary pressure chamber 62B in order to move the second locking element 60 between a release position and a locking position along the Z-axis. In the release position of the second locking element 60, a compensation movement along the X-axis and Y-axis can take place by the second compensation unit 14. In the locking position of the second locking element 60, no compensation movement can take place by the second compensation unit 14, since a cone 61 of the second locking element 60 contacts a cone receptacle 63 of the second compensation part 28 and displaces the second compensation part 28 into the second basic position.

According to FIG. 5, the third compensation unit 16 also has a third locking unit 64. The third locking unit 64 has a third locking housing 66, a third cylinder chamber 68 and a third locking element 70. The third locking element 70 has a third cylinder portion 72 arranged in the third cylinder chamber 68, which divides the third cylinder portion 72 into a third primary pressure chamber 74A and a third secondary pressure chamber 74B. Pressure can be applied to the third primary pressure chamber 74A and/or the third secondary pressure chamber 74B for moving the third locking element 70 between a release position and a locking position along the Z-axis. In the release position of the third locking element 70, a compensation movement about the X-axis and about the Y-axis can take place by the third compensation unit 16. In the locking position of the third locking element 70, no compensation movement can take place by the third compensation unit 16, since a contact surface 71 of the third locking element 70 contacts a contact surface 73 of the third compensation part 38 and displaces the third compensation part 38 into the third basic position.

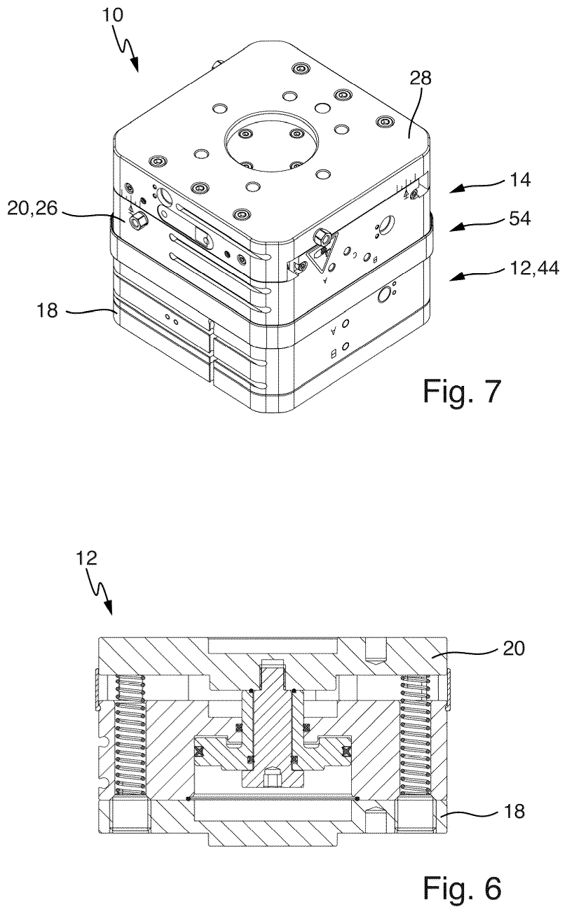

According to FIG. 6, in some existing systems, a first compensation unit 12 is designed as a separate module and therefore comprises a first base part 18 and a first compensation part 20, independently of the further compensation units 14, 16 and independently of the locking units 44, 54, 64. This results in the compensation device 10 that uses such a compensation unit being overall heavy and high in construction.

From FIG. 3 to 5 and 8 to 11 it can be seen that the first compensation part 20 is formed integrally with a locking housing 56, 66 of an adjacent locking unit 54, 64. In FIG. 3 to 5, the first compensation part 20 is formed integrally with the second locking housing 56, the spring device 22 being directly supported on the second locking housing 56 and the guide device 24 being arranged within the second locking housing 56. FIG. 10 shows an alternative combination (right-hand side), the first compensation part 20 being formed integrally with the third locking housing 66. Accordingly, this compensation device 10 is particularly flat and lightweight.

The locking housings 56, 66 can each have a housing cover 57 which limits and/or closes the respective cylinder chamber on the handling side or the tool side. The housing cover 57 is connected, for example, screwed, to a housing casing 59 in order to close the respective cylinder chamber. The spring device 22 and/or guide device 24 can adjoin the housing cover 57 and/or are arranged therein, at least in part.

This principle can alternatively also be applied to the other compensation units, for example the second compensation part 28 or the third compensation part 38 being formed integrally with an adjacent locking housing 46, 56, 66. Accordingly, the second compensation part 28 can be formed integrally with the first locking housing 46 or the third locking housing 66. Alternatively, the third compensation part 38 can be formed with the first locking housing 46 or the second locking housing 56. Furthermore, the first compensation part 20 can be formed integrally with the second base part 26 or the third base part 36. In addition, in some aspects of the present disclosure, the second compensation part 28 is formed integrally with the first base part 18 or the third base part 36 and/or that the third compensation part 38 is formed integrally with the first base part 18 or the second base part 26.

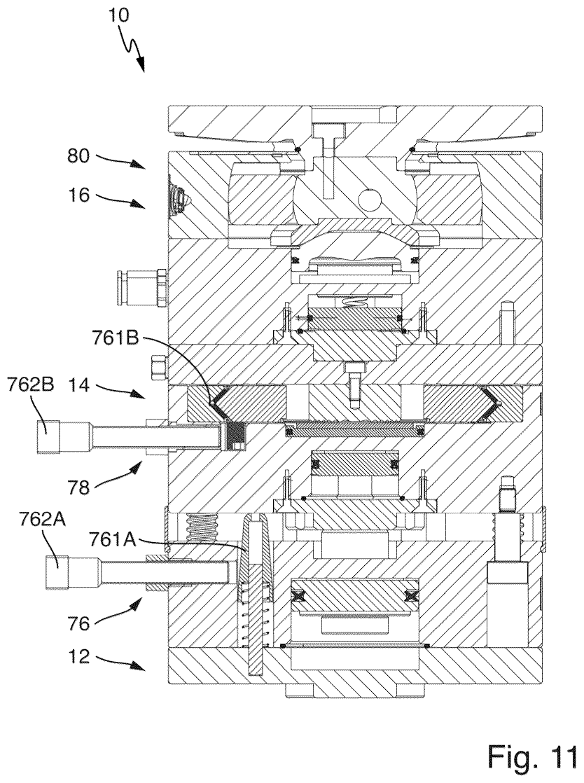

In FIG. 11, a first compensation sensor device 76 of the first compensation unit 12 and a second compensation sensor device 78 of the second compensation unit 14 can be seen.

The first compensation sensor device 76 comprises a first signal generator 761A and a first signal receiver 762A, the first signal receiver 762A being displaced into the first compensation position relative to the first signal generator 761A during a compensation movement. The first signal generator 761A detects the displacement and can use this to determine the compensation movement of the first compensation unit 12. Due to the one-dimensionality of the first compensation unit 12, a single sensor pair is sufficient.

The second compensation sensor device 78 comprises a second signal generator 761B and a second signal receiver 762B for each compensation direction (X-axis and Y-axis), the second signal receiver 762B being displaced into the second compensation position relative to the second signal generator 761B during a compensation movement. The second signal generator 761B detects the displacement and can use this to determine the compensation movement of the second compensation unit 14. Due to the two-dimensionality of the compensation movement of the second compensation unit 14, one sensor pair can be utilized for each compensation direction.

The third compensation unit 16 also has a third compensation sensor device 80, which also comprises two sensor pairs for detecting the (rotational) turning about the X-axis and the Y-axis.

Furthermore, each locking unit can include a locking sensor device. A sensor pair can also be provided for detecting the stroke and/or the position of the locking element.

The compensation sensor devices and/or locking sensor devices can be arranged on or in the housing, for example, in a sensor groove, of the respective component. The sensor groove can be arranged, for example, on the lateral surface of the respective housing.

The data from the sensor devices can be used to control the handling device, the compensation units and/or the locking units. The sensor data are made available to a higher-level handling controller, which controls the handling device, the compensation units and/or the locking units depending on the sensor data.

In various aspects of the present disclosure, the integration of components of the compensation units with locking housings can reduce the number of separate parts and can provide a more compact and lightweight compensation device. By moving the geometric center of gravity of the load closer to the handling device, permissible loads can be increased and energy consumption and mechanical wear can be reduced in some applications. The modular arrangement of vertical, horizontal, and rotatory compensation units can allow the compensation device to be adapted to different handling tasks and installation spaces. In addition, the use of compensation sensor devices and locking sensor devices, together with a controller that evaluates sensor data in real time, can permit precise and repeatable positioning, shortened cycle times, and improved operational reliability. These and other advantages will be apparent to persons skilled in the art in view of the present disclosure.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

### LIST OF REFERENCE SIGNS

10 compensation device
12 first compensation unit
14 second compensation unit
16 third compensation unit
18 first base part
20 first compensation part
22 spring device
24 guide device
26 second base part
28 second compensation part
30 guide frame
32 first linear guide
34 second linear guide
36 third base part
38 third compensation part
40 bearing frame
42 bearing core
44 first locking unit
46 first locking housing
48 first cylinder chamber
48A first primary pressure chamber
48B first secondary pressure chamber
50 first locking element
52 first cylinder portion
54 second locking unit
541 magnetic pin
543 groove
56 second locking housing
57 housing cover
58 second cylinder chamber
59 housing casing
60 second locking element
61 cone
62 second cylinder portion
63 cone receptacle
62A second primary pressure chamber
62B second secondary pressure chamber
64 third locking unit
66 third locking housing
68 third cylinder chamber
70 third locking element
71 contact surface
72 third cylinder portion
73 contact surface
74A third primary pressure chamber
74B third secondary pressure chamber
76 first compensation sensor device
761 signal generator
762 signal receiver
78 second compensation sensor device
80 third compensation sensor device

What is claimed:

1. A compensation device for an automation system, configured for arrangement between a handling device and a tool, the compensation device comprising:
a first compensation unit including a first base part and a first compensation part, the first compensation part being movable relative to the first base part between a first basic position and a first compensation position;
at least one second compensation unit including a second base part and a second compensation part, the second compensation part being movable relative to the second base part between a second basic position and a second compensation position; and
at least one locking unit configured to lock at least one of the first compensation part and the at least one second compensation part in the second basic position, the locking unit including a locking element that is displaceable in a locking housing between a release position and a locking position;
wherein at least one of the following is satisfied:
(a) the first base part is formed integrally with at least one of the locking housing and the second compensation part; and
(b) the first compensation part is formed integrally with at least one of the locking housing and the second base part.

2. The compensation device of claim 1, wherein the locking unit is driven pneumatically, hydraulically, or by a combination of pneumatic and hydraulic actuation.

3. The compensation device of claim 1, wherein the locking housing defines a cylinder chamber, and wherein the locking element includes a cylinder portion arranged in the cylinder chamber.

4. The compensation device of claim 1, wherein the first compensation unit includes a first spring device configured to return the first compensation part to the first basic position, and wherein the first spring device is arranged on or in the locking housing.

5. The compensation device of claim 1, wherein the first compensation unit includes a first guide device arranged on or in the locking housing.

6. The compensation device of claim 1, wherein the first compensation part is movable relative to the first base part along a Z-axis from the first basic position into the first compensation position.

7. The compensation device of claim 1, wherein the second compensation part is movable relative to the second base part along an X-axis that is perpendicular to the Z-axis and along a Y-axis that is perpendicular to the X-axis, from the second basic position into the second compensation position.

8. The compensation device of claim 1, wherein the second compensation part is pivotable relative to the second base part about the X-axis and about the Y-axis, from the second basic position into the second compensation position.

9. The compensation device of claim 1, wherein the locking element is displaceable along the Z-axis between the release position and the locking position.

10. The compensation device of claim 1, wherein at least one of the first compensation unit and the at least one second compensation unit includes a compensation sensor device configured to detect a position of an associated compensation part.

11. The compensation device of claim 10, wherein the at least one locking unit includes at least one locking sensor device configured to detect a position of an associated locking element.

12. The compensation device of claim 11, wherein the compensation sensor device and the locking sensor device each include at least one of: an incremental sensor, an inductive position detection sensor, or a magnetic sensor.

13. A system comprising:
a handling device; and
a compensation device according to claim 1;
wherein the handling device includes a handling controller, and the compensation device includes a compensation controller integrated with the handling controller;
wherein each of a plurality of compensation units of the compensation device includes a compensation sensor device configured to detect at least one of a position, a stroke, or a path of an associated compensation part; and
wherein the handling controller is configured to control the handling device based on sensor data detected by the compensation sensor devices of the compensation units.

14. A computer-implemented method for controlling a handling device that operates with a compensation device having a plurality of compensation units with associated compensation sensor devices, the method comprising:
detecting, by the compensation sensor devices, a compensation movement when the handling device approaches a target position;
determining, by a controller, a compensation offset based on the detected compensation movement;
when the handling device approaches the target position again, approaching the target position while taking into account the determined compensation offset such that no compensation movement or a reduced compensation movement of at least one of the compensation units is required; and
releasing at least one compensation unit along compensated compensation directions and locking at least one compensation unit along uncompensated compensation directions by associated locking units, based on the determined compensation offset.
